(19) United States
(12) Patent Application Publication
(10) Pub. No.: US 2026/0173154 A1
(43) Pub. Date: Jun. 18, 2026

(54) NPCA OPERATION FOR ASYMMETRIC CHANNEL SWITCHING

(71) Applicant: Senscomm Semiconductor Co., Ltd., Suzhou (CN)

(72) Inventors: Sung Jin PARK, Seoul (KR); DAEHONG KIM, Irvine, CA (US)

(21) Appl. No.: 19/411,105

(22) Filed: Dec. 5, 2025

Related U.S. Application Data
(60) Provisional application No. 63/734,692, filed on Dec. 16, 2024.

(51) Int. Cl. H04W 74/0833

(52) U.S. Cl. CPC H04W 74/0833

(57) ABSTRACT

Disclosed are channel switching procedures and protocols to maintain bidirectional communication and alleviate OBSS interference when a mismatch in channel switching states occurs between an AP and a non-AP STA of a Wi-Fi network. Asymmetrical channel switching scenarios may arise due to different positionings and physical distances of the AP and the non-AP STA from the OBSS. A wireless communication device includes processing circuitry configured to cause the wireless communication device to detect interference on a basic service set (BSS) primary channel used for communicating with an AP. The processing circuitry is further configured to cause the wireless communication device to switch from the BSS primary channel to a non-primary channel access (NPCA) basic channel in response to the interference; perform a channel switching procedure with the AP for the AP to switch to the NPCA basic channel; and perform data communication with the AP using the NPCA basic channel.

### CROSS-REFERENCE TO RELATED APPLICATIONS

This application claims the benefit of priority from U.S. Provisional Application No. 63/734,692, filed on Dec. 16, 2024, the entire contents of which are herein incorporated by reference.

### TECHNICAL FIELD

The disclosure relates to wireless communication systems, and more particularly to, but not limited to, a protocol for switching an operating channel of a wireless network from a primary channel to a pre-negotiated auxiliary channel to maintain bidirectional communication when interference is encountered on the primary channel.

### BACKGROUND

In Wi-Fi networks, performance degradation frequently occurs due to interference caused by OBSS (Overlapping Basic Service Set) operating on the same channel. To address this issue, Non-Primary Channel Access (NPCA) has been proposed, which allows STAs (Stations) to switch to an NPCA basic channel to transmit and receive data, avoiding interference. However, there is a significant risk of communication disruption or reduced efficiency if the channel switching states of the AP (Access Point) and STAs do not align.

For example, communication problems may arise in the following cases: 1) when the AP maintains the BSS (Basic Service Set) primary channel while the STA switches to the NPCA basic channel; and 2) when the AP switches to the NPCA basic channel while the STA remains on the BSS primary channel. When asymmetric NPCA switching scenarios arise, the AP and the STA may end up communicating on different channels, causing unreliable communication and degrading performance.

The description set forth in the background section should not be assumed to be prior art merely because it is set forth in the background section. The background section may describe aspects or embodiments of the present disclosure.

### SUMMARY

Some aspects of this disclosure are directed to techniques to maintain bidirectional communication and alleviate OBSS interference when a mismatch in channel switching states occurs between an AP and a non-AP STA.

In some embodiments, a wireless communication device for facilitating wireless communication, includes processing circuitry configured to cause: detecting interference on a basic service set (BSS) primary channel used for communicating with an AP; switching from the BSS primary channel to a non-primary channel access (NPCA) basic channel in response to the interference; performing a channel switching procedure with the AP for the AP to switch to the NPCA basic channel; and performing data communication with the AP using the NPCA basic channel.

In some embodiments, performing the channel switching procedure with the AP for the AP to switch to the NPCA basic channel by the processing circuitry of the wireless communication device includes receiving a trigger frame from the AP on the NPCA basic channel; and transmitting a response frame to the AP on the NPCA basic channel to indicate the switching from the BSS primary channel to the NPCA basic channel in response to the trigger frame

In some embodiments, the trigger frame includes resource allocation information corresponding to the NPCA basic channel.

In some embodiments, transmitting the response frame to the AP by the processing circuitry of the wireless communication device includes transmitting the response frame to the AP on the NPCA basic channel to indicate the switching to the NPCA basic channel using a resource unit allocated based on the resource allocation information.

In some embodiments, performing the channel switching procedure with the AP for the AP to switch to the NPCA basic channel by the processing circuitry of the wireless communication device includes receiving a second trigger frame from the AP on the NPCA basic channel, wherein the second trigger frame includes resource allocation information corresponding to the NPCA basic channel, and wherein performing data communication with the AP by the processing circuitry of the wireless communication device includes transmitting data to the AP using a resource unit allocated based on the resource allocation information.

In some embodiments, performing the channel switching procedure with the AP for the AP to switch to the NPCA basic channel by the processing circuitry of the wireless communication device further includes transmitting a random access request to the AP on the NPCA basic channel as part of a random access procedure; and receiving access to the NPCA basic channel, and wherein performing data communication with the AP by the processing circuitry of the wireless communication device includes transmitting data to the AP on the NPCA basic channel.

In some embodiments, performing the channel switching procedure with the AP for the AP to switch to the NPCA basic channel by the processing circuitry of the wireless communication device includes receiving a request to send (RTS) frame on the NPCA basic channel; and transmitting a clear to send (CTS) frame on the NPCA basic channel.

In some embodiments, detecting interference on the BSS primary channel by the processing circuitry of the wireless communication device includes detecting a transmit opportunity from an overlapping basic service set (OBSS).

In some embodiments, a wireless communication device for facilitating wireless communication includes processing circuitry configured to cause: receiving a switching command from an AP on a BSS primary channel used for communicating with the AP; switching from the BSS primary channel to a NPCA basic channel in response to the switching command; and performing data communication with the AP using the NPCA basic channel.

In some embodiments, an access point (AP) for facilitating wireless communication includes processing circuitry configured to cause: configuring a BSS primary channel used for communicating with one or more wireless stations associated with the AP station; performing a channel switching procedure with the one or more wireless stations for one wireless station to operate on a NPCA basic channel; and performing data communication with the one wireless station using the NPCA basic channel.

In some embodiments, performing the channel switching procedure with the one or more wireless stations for the one wireless station to operate on the NPCA basic channel by the processing circuitry of the AP includes: transmitting a trigger frame to the one or more wireless stations on the NPCA basic channel; and receiving a response frame from the one wireless station on the NPCA basic channel to indicate the one wireless station switched from the BSS primary channel to the NPCA basic channel.

In some embodiments, the trigger frame includes resource allocation information to allocate a resource unit corresponding to the NPCA basic channel.

In some embodiments, receiving the response frame from the one wireless station by the processing circuitry of the AP includes: receiving the response frame from the one wireless station on the NPCA basic channel on the resource unit allocated by the resource allocation information.

In some embodiments, performing the channel switching procedure with the one or more wireless stations for the one wireless station to operate on the NPCA basic channel by the processing circuitry of the AP further includes transmitting a second trigger frame to the one wireless station on the NPCA basic channel in response to the response frame, wherein the second trigger frame includes resource allocation information to allocate a resource unit corresponding to the NPCA basic channel, and wherein performing data communication with the one wireless station by the processing circuitry of the AP includes receiving data from the one wireless station on a resource unit allocated by the resource allocation information.

In some embodiments, performing the channel switching procedure with the one or more wireless stations for the one wireless station to operate on the NPCA basic channel by the processing circuitry of the AP further includes receiving a random access request from the one wireless station on the NPCA basic channel as part of a random access procedure; and granting, to the one wireless station, access to the NPCA basic channel, and wherein performing data communication with the one wireless station by the processing circuitry of the AP includes receiving data from one wireless station on the NPCA basic channel.

In some embodiments, performing the channel switching procedure with the one or more wireless stations for the one wireless station to operate on the NPCA basic channel by the processing circuitry of the AP includes: transmitting a request to send (RTS) frame on the BSS primary channel to the one or more wireless stations; determining a failure to receive a clear to send (CTS) frame on the BSS primary channel from the one or more wireless stations; retransmitting the RTS frame on the NPCA basic channel to the one or more wireless stations; and receiving a CTS frame from the one wireless station on the NPCA basic channel.

In some embodiments, performing the channel switching procedure with the one or more wireless stations for the one wireless station to operate on the NPCA basic channel by the processing circuitry of the AP includes: determining that the one wireless station is operating on the NPCA basic channel; transmitting a request to send (RTS) frame on the NPCA basic channel to the one wireless station; and receiving a clear to send (CTS) frame from the one wireless station on the NPCA basic channel.

In some embodiments, determining that the one wireless station is operating on the NPCA basic channel by the processing circuitry of the AP includes: transmitting a trigger frame to the one or more wireless stations on the NPCA basic channel; and receiving a response frame from the one wireless station on the NPCA basic channel to indicate the one wireless station switched from the BSS primary channel to the NPCA basic channel.

In some embodiments, performing the channel switching procedure with the one or more wireless stations for the one wireless station to operate on the NPCA basic channel by the processing circuitry of the AP includes: detecting interference on the BSS primary channel; transmitting a command on the BSS primary channel to instruct the one or more wireless stations to switch from the BSS primary channel to the NPCA basic channel; and switching the AP from the BSS primary channel to the NPCA basic channel for communicating with the one or more wireless stations.

In some embodiments, detecting interference on the BSS primary channel by the processing circuitry of the AP includes: detecting a transmit opportunity from an overlapping basic service set (OBSS).

### BRIEF DESCRIPTION OF THE DRAWINGS

FIG. 1 illustrates a schematic diagram of an example wireless communication network.

FIG. 2 illustrates an example of a timing diagram of interframe space (IFS) relationships between stations in accordance with an embodiment.

FIG. 3 shows an OFDM symbol and an OFDMA symbol in accordance with an embodiment.

FIG. 4A illustrates the EHT MU PPDU format in accordance with an embodiment.

FIG. 4B illustrates the EHT TB PPDU format in accordance with an embodiment.

FIG. 5 is a block diagram of an electronic device for facilitating wireless communication in accordance with an embodiment.

FIG. 6 shows a block diagram of a transmitter in accordance with an embodiment.

FIG. 7 shows a block diagram of a receiver in accordance with an embodiment.

FIG. 8 shows an OBSS network topology in accordance with an embodiment.

FIG. 9 shows scenarios for an NPCA when there is interference on the primary channel of a BSS from an OBSS in accordance with an embodiment.

FIG. 10 shows channel switching by the AP and STA to the NPCA primary channel in accordance with an embodiment.

FIG. 11 shows an asymmetrical switching scenario when channel switching to the NPCA primary channel occurs for the AP but not for the STA under one scenario.

FIG. 12 shows an asymmetrical NPCA switching scenario when channel switching to the NPCA primary channel occurs for the STA but not for the AP under another scenario.

FIG. 13 shows a data transmission protocol for the AP to determine if an NPCA-supported STA (NPCA STA) has switched to the NPCA primary channel when the AP acquires a TXOP in accordance with one embodiment.

FIG. 14 shows a data transmission protocol for the AP to determine if an NPCA STA has switched to the NPCA primary channel when the NPCA STA acquires a TXOP in accordance with one embodiment.

FIG. 15 shows a data transmission protocol for the AP to determine if an NPCA STA has switched to the NPCA primary channel when the NPCA STA acquires a TXOP in accordance with another embodiment.

FIG. 16 shows a channel switching procedure for the AP to command STAs associated with the AP to switch to the NPCA primary channel in accordance with one embodiment.

FIG. 17 shows an example process for a STA to switch from a BSS primary channel to a NPCA primary channel in accordance with one embodiment.

FIG. 18 shows an example process for an AP to switch from a BSS primary channel to a NPCA primary channel in accordance with one embodiment.

### DETAILED DESCRIPTION

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In some embodiments, apparatus or devices such as an AP STA and a non-AP may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

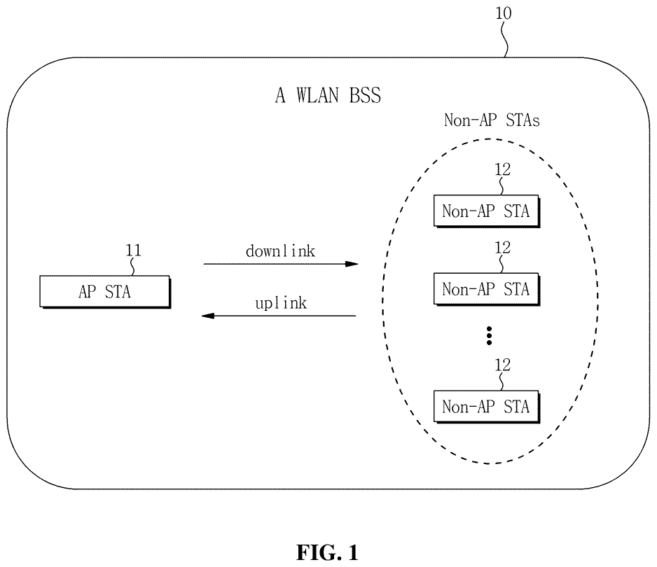

FIG. 1 illustrates a schematic diagram of an example wireless communication network.

Referring to FIG. 1, a basic service set (BSS) 10 may include a plurality of stations (STAs) including an access point (AP) station (AP STA) 11 and one or more non-AP station (non-AP STA) 12. For convenience, the non-AP STA may be referred to interchangeably as a user or an STA. The STAs may share a same radio frequency channel having a bandwidth selected from those (e.g., 20/40/80/160/320 MHz) used for WLAN operation. Hereinafter, in some embodiments, the AP STA and the non-AP STA may be referred as AP and STA, respectively. In some embodiments, the AP STA and the non-AP STA may be collectively referred as station (STA).

The plurality of STAs may participate in multi-user (MU) transmission. In the MU transmission, the AP STA 11 may simultaneously transmit the downlink (DL) frames to the multiple non-AP STAs 12 in the BSS 10 based on different resources and the multiple non-AP STAs 12 may simultaneously transmit the uplink (UL) frames to the AP STA 11 in the BSS 10 based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may either simultaneously transmit to the AP STA 11 (UL-MU-MIMO) or simultaneously receive from the AP STA 11 (DL-MU-MIMO) independent data streams over the same subcarriers. Different spatial streams may be used as the different resources in MU-MIMO transmission. In OFDMA transmission, the multiple non-AP STAs 12 may either simultaneously transmit to the AP STA 11 (UL-OFDMA) or simultaneously receive from the AP STA 11 (DL-OFDMA) independent data streams over different groups of subcarriers. Different frequency resources may be used as the different resources in the OFDMA transmission.

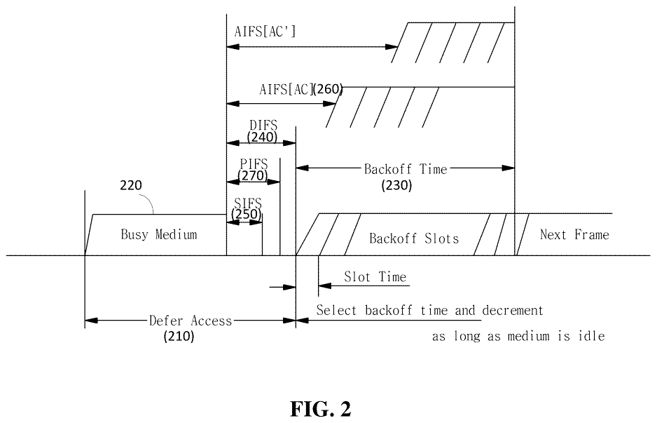

FIG. 2 illustrates an example of a timing diagram of interframe space (IFS) relationships between stations in accordance with an embodiment.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred 210 while the medium is busy 220 until a type of IFS duration has elapsed. The STA may transmit the data frame after performing backoff 230 if a distributed coordination function IFS (DIFS) 240 has elapsed from a time when the medium has been idle.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame may include a request to send (RTS) frame, a clear to send (CTS) frame, and an acknowledgement (ACK) frame. In the case that the control frame is not a response frame of the other frame, the STA may transmit the control frame after performing backoff 230 if the DIFS 240 has elapsed. If the control frame is the response frame of a previous frame, the WLAN device may transmit the control frame without performing backoff when a short IFS (SIFS) 250 has elapsed. The type and subtype of frame may be identified by a type field and a subtype field in a frame control field.

In some embodiments, a Quality of Service (QoS) STA may transmit the frame after performing backoff if an arbitration IFS (AIFS) for access category (AC), i.e., AIFS[AC] 260 has elapsed. In this case, the data frame, the management frame, or the control frame which is not the response frame may use the AIFC[AC] 260.

In some embodiments, a point coordination function (PCF) enabled AP STA may transmit the frame after performing backoff if a PCF IFS (PIFS) 270 has elapsed. The PIFS 270 duration may be less than the duration of DIFS 240 but greater than the duration of SIFS 250.

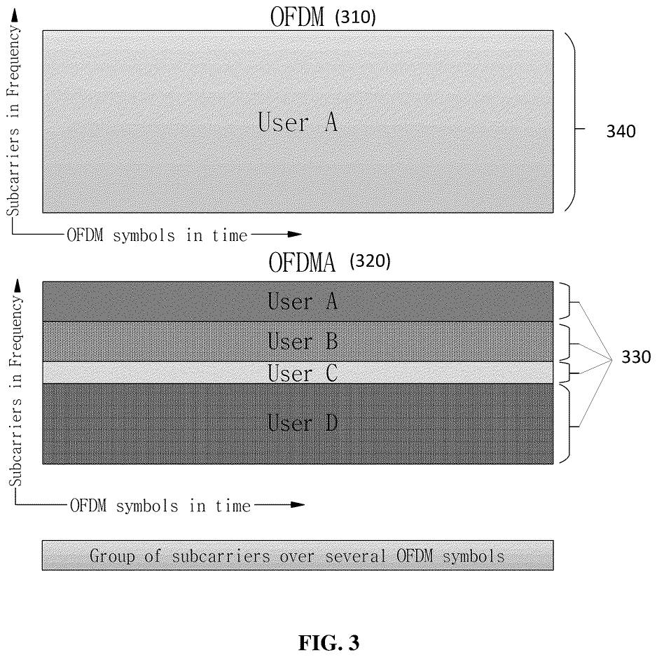

FIG. 3 shows an OFDM symbol and an OFDMA symbol in accordance with an embodiment.

For multi-user access modulation, the orthogonal frequency division multiple access (OFDMA) 320 for uplink and downlink has been introduced in IEEE 802.11ax standard known as High-Efficiency (HE) WLAN and will be used in 802.11's future amendments such as IEEE 802.11be EHT (Extremely High Throughput). One or more STAs may be allowed to use one or more resource units (RUs) throughout an operation bandwidth to transmit data at the same time. An RU is the minimum granularity of the frequency resources allocated for the transmission and may comprise a group of a predefined number of subcarriers. An RU may be located at a predefined location in an orthogonal frequency division multiplexing (OFDM) modulation symbol. Here, non-AP STAs may be associated or non-associated with an AP STA when responding simultaneously in the assigned RUs within a specific period such as a short inter frame space (SIFS) 250 of FIG. 2. The SIFS may refer to the time duration from the end of the last symbol, or signal extension if present, of the previous frame to the beginning of the first symbol of the preamble of the subsequent frame.

The OFDMA 320 is an OFDM-based multiple access scheme where different subsets of subcarriers 330 may be allocated to different users, allowing simultaneous data transmission to or from one or more users with highly accurate synchronization for frequency orthogonality. In OFDMA 320, users may be allocated different subsets of subcarriers which can change from one physical layer (PHY) protocol data unit (PPDU) to the next. In OFDMA 320, an OFDM symbol is constructed of subcarriers, the number of which is a function of the PPDU bandwidth. In OFMA 310, a user may be allocated all of the subcarriers 340. The difference between OFDM 310 and OFDMA 320 is illustrated in FIG. 3.

In a case of UL MU transmission, given different STAs with their own capabilities and features, the AP STA may want to have more control of the medium by using more scheduled access, which may allow more frequent use of OFDMA/MU-MIMO transmissions. For example, PPDUs in UL MU transmission (MU-MIMO or OFDMA) may be sent as a response to a trigger frame sent by the AP. The trigger frame may include information for a STA and may assign one or more RUs (e.g., multiple RUs (MRUs)) to STAs. In one embodiment, the STA's information in the trigger frame may comprise STA Identification (ID), MCS (modulation and coding scheme), and frame length. The trigger frame may trigger a STA to transmit an OFDMA-based packet as trigger-based (TB) PPDU (e.g., HE TB PPDU or EHT TB PPDU). The TB PPDU is segmented into RUs and all RUs may be allocated to the solicited non-AP STAs as a response to the trigger frame. Hereinafter, a single RU and multiple RUs may be referred to as the RU. The multiple RUs may include, or consist of, predefined two, three, or more RUs.

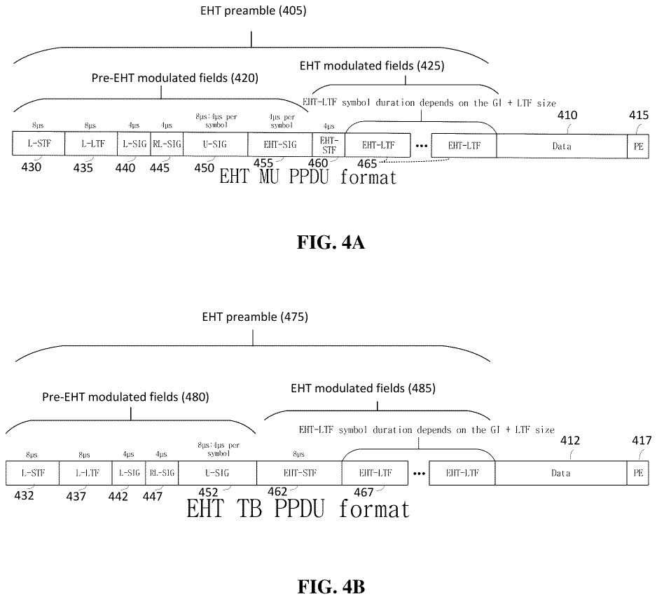

In EHT, two EHT PPDU formats are defined: the EHT MU PPDU and the EHT TB PPDU. Hereinafter, the EHT MU PPDU and the EHT TB PPDU will be described with reference to FIG. 4A and FIG. 4B.

FIG. 4A illustrates the EHT MU PPDU format in accordance with an embodiment.

The EHT MU PPDU may be used for transmission to one or more users. The EHT MU PPDU is not a response to a triggering frame.

Referring to FIG. 4A, the EHT MU PPDU may include, or consist of, an EHT preamble 405 (hereinafter referred to as a PHY preamble or a preamble), a data field 410, and a packet extension (PE) field 415. The EHT preamble 405 may include, or consist of, pre-EHT modulated fields 420 and EHT modulated fields 425. The pre-EHT modulated fields 420 may include, or consist of, a Non-High Throughput (non-HT) short training field (L-STF) 430, a Non-HT long training field (L-LTF) 435, a Non-HT signal (L-SIG) field 440, a repeated Non-HT signal (RL-SIG) field 445, a universal signal (U-SIG) field 450, and an EHT signal (EHT-SIG) field 455. The EHT modulated fields 425 may include, or consist of, an EHT short training field (EHT-STF) 460 and an EHT long training field (EHT-LTF) 465. In some embodiments, the data field 410 and the PE field 415 may be considered part of the EHT modulated fields 425. In some embodiments, the L-STF field 430 may be immediately followed by the L-LTF field 435, which is immediately followed by the L-SIG field 440, which is immediately followed by the RL-SIG field 445, which is immediately followed by the U-SIG field 450, which is immediately followed by the EHT-SIG field 455, which is immediately followed by the EHT-STF field 460, which is immediately followed by the EHT-LTF field 465, which is immediately followed by the data field 410, which is immediately followed by the PE field 415.

The L-STF field 430 may be utilized for packet detection, automatic gain control (AGC), and coarse frequency-offset correction.

The L-LTF field 435 may be utilized for channel estimation, fine frequency-offset correction, and symbol timing.

The L-SIG field 440 may be used to communicate rate and length information.

The RL-SIG field 445 may be a repeat of the L-SIG field and may be used to differentiate an EHT PPDU from a non-HT PPDU, HT PPDU, and Very High Throughput (VHT) PPDU.

The U-SIG field 450 may carry information necessary to interpret EHT PPDUs.

The EHT-SIG field 455 may provide additional signaling to the U-SIG field for STAs to interpret an EHT MU PPDU. Hereinafter, the U-SIG field 450, the EHT-SIG field 455, or both may be referred to as the SIG field.

The EHT-SIG field 455 may include one or more EHT-SIG content channel. Each of the one or more EHT-SIG content channel may include a common field and a user specific field. The common field may contain information regarding the resource unit allocation such as the RU assignment to be used in the EHT modulated fields 425 of the PPDU, the RUs allocated for MU-MIMO and the number of users in MU-MIMO allocations. The user specific field may include one or more user fields.

The user field for a non-MU-MIMO allocation may include a STA-ID subfield, a Modulation and Coding Scheme (MCS) subfield, a Number of Spatial Streams (NSS) subfield, a beamformed subfield, and a coding subfield. The user field for a MU-MIMO allocation may include a STA-ID subfield, a MCS subfield, a coding subfield, and a spatial configuration subfield.

The EHT-STF field 460 may be used to improve automatic gain control estimation in a MIMO transmission.

The EHT-LTF field 465 may enable the receiver to estimate the MIMO channel between the set of constellation mapper outputs and the receive chains.

The data field 410 may carry one or more physical layer convergence procedure (PLCP) service data units (PSDUs).

The PE field 415 may provide additional receive processing time at the end of the EHT MU PPDU.

FIG. 4B illustrates the EHT TB PPDU format in accordance with an embodiment.

The EHT TB PPDU may be used for a transmission of a response to a triggering frame.

Referring to FIG. 4B, the EHT TB PPDU may include, or consist of, an EHT preamble 475 (hereinafter referred to as a PHY preamble or a preamble), a data field 412, and a packet extension (PE) field 417. The EHT preamble 475 may include, or consist of, pre-EHT modulated fields 480 and EHT modulated fields 485. The pre-EHT modulated fields 480 may include, or consist of, a Non-HT short training field (L-STF) 432, a Non-HT long training field (L-LTF) 437, a Non-HT signal (L-SIG) field 442, a repeated Non-HT signal (RL-SIG) field 447, and a universal signal (U-SIG) field 452. The EHT modulated fields 485 may include, or consist of, an EHT short training field (EHT-STF) 462 and an EHT long training field (EHT-LTF) 467. In some embodiments, the data field 412 and the PE field 417 may be considered part of the EHT modulated fields 485. In some embodiments, the L-STF field 432 may be immediately followed by the L-LTF field 437, which is immediately followed by the L-SIG field 442, which is immediately followed by the RL-SIG field 447, which is immediately followed by the U-SIG field 452, which is immediately followed by the EHT-STF field 462, which is immediately followed by the EHT-LTF field 467, which is immediately followed by the data field 412, which is immediately followed by the PE field 417. In the EHT TB PPDU, the EHT-SIG field 455 is not present because the trigger frame conveys necessary information and the duration of the EHT_STF field 462 in the EHT TB PPDU is twice the duration of the EHT-STF field 460 in the EHT MU PPDU.

Description for each field in the EHT TB PPDU will be omitted because description for each field in the EHT MU PPDU is applicable to the EHT TB PPDU.

For EHT MU PPDU and EHT TB PPDU, when the EHT modulated fields 425 or 485 occupy more than one 20 MHz channels, the pre-EHT modulated fields 420 or 480 may be duplicated over multiple 20 MHz channels.

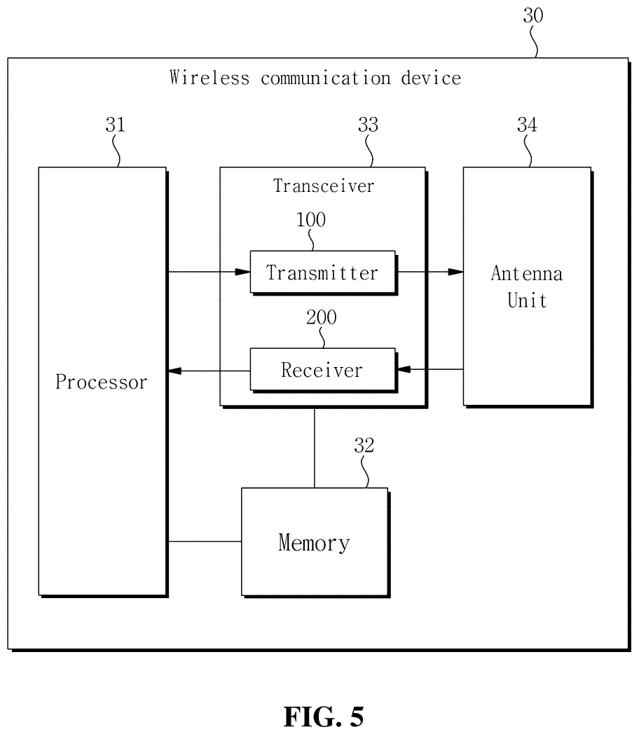

Hereinafter, electronic devices for facilitating wireless communication in accordance with various embodiments will be described with reference to FIG. 5.

FIG. 5 is a block diagram of an electronic device for facilitating wireless communication in accordance with an embodiment.

Referring to FIG. 5, an electronic device 30 for facilitating wireless communication in accordance with an embodiment may include a processor 31, a memory 32, a transceiver 33, and an antenna unit 34. The transceiver 33 may include a transmitter 100 and a receiver 200.

The processor 31 may perform medium access control (MAC) functions, PHY functions, RF functions, or a combination of some or all of the foregoing. In some embodiments, the processor 31 may comprise some or all of a transmitter 100 and a receiver 200. The processor 31 may be directly or indirectly coupled to the memory 32. In some embodiments, the processor 31 may include one or more processors.

The memory 32 may be non-transitory computer-readable recording medium storing instructions that, when executed by the processor 31, cause the electronic device 30 to perform operations, methods or procedures set forth in the present disclosure. In some embodiments, the memory 32 may store instructions that are needed by one or more of the processor 31, the transceiver 33, and other components of the electronic device 30. The memory may further store an operating system and applications. The memory 32 may comprise, be implemented as, or be included in a read-and-write memory, a read-only memory, a volatile memory, a non-volatile memory, or a combination of some or all of the foregoing.

The antenna unit 34 includes one or more physical antennas. When multiple-input multiple-output (MIMO) or multi-user MIMO (MU-MIMO) is used, the antenna unit 34 may include more than one physical antennas.

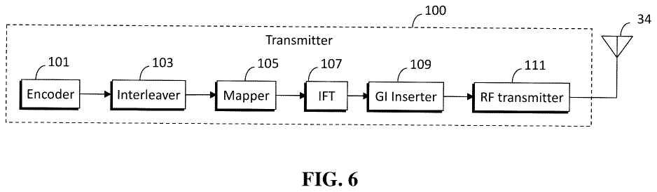

FIG. 6 shows a block diagram of a transmitter 100 in accordance with an embodiment.

Referring to FIG. 6, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder. In some embodiments, a scrambler may scramble the input data based on a scrambler seed before feeding the scrambled input data to the encoder 101 for encoding.

The interleaver 103 may interleave bits of encoded data from the encoder 101 to change the order of bits, and output interleaved data. In some embodiments, interleaving may be applied when BCC encoding is employed.

The mapper 105 may map interleaved data into constellation points to generate a block of constellation points. If the LDPC encoding is used in the encoder 101, the mapper 105 may further perform LDPC tone mapping instead of the constellation mapping.

The IFT 107 may convert the block of constellation points into a time domain block corresponding to a symbol by using an inverse discrete Fourier transform (IDFT) or an inverse fast Fourier transform (IFFT).

The GI inserter 109 may prepend a GI to the symbol.

The RF transmitter 111 may convert the symbols into an RF signal and transmits the RF signal via the antenna unit 34.

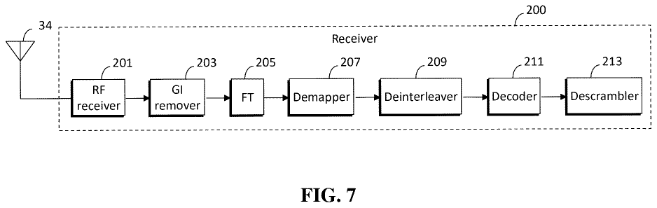

FIG. 7 shows a block diagram of a receiver 200 in accordance with an embodiment.

Referring to FIG. 7, the receiver 200 in accordance with an embodiment may include a RF receiver 201, a GI remover 203, a Fourier transformer (FT) 205, a demapper 207, a deinterleaver 209, and a decoder 211.

The RF receiver 201 may receive an RF signal via the antenna unit 34 and converts the RF signal into one or more symbols.

The GI remover 203 may remove the GI from the symbol.

The FT 205 may convert the symbol corresponding a time domain block into a block of constellation points by using a discrete Fourier transform (DFT) or a fast Fourier transform (FFT) depending on implementation.

The demapper 207 may demap or demodulate the block of constellation points to demapped data bits. If the LDPC encoding is used, the demapper 207 may further perform LDPC tone demapping before the constellation demapping.

The deinterleaver 209 may deinterleave demapped data bits to generate deinterleaved data bits. In some embodiments, deinterleaving may be applied when BCC encoding is used.

The decoder 211 may decode the deinterleaved data bits to generate decoded bits. For example, the decoder 211 may be an FEC decoder. The FEC decoder may include a BCC decoder or an LDPC decoder. In order to support the Hybrid Automatic Repeat Request (HARQ) procedure, the decoder 211 may combine a retransmitted data with an initial data.

The descrambler 213 may descramble the scrambled data bits based on a scrambler seed.

The IEEE 802.11be EHT is the next generation Wi-Fi standard that seeks to achieve higher data rate, lower latency, and more reliable connection to enhance user experience. One of the key features of the IEEE 802.11be standard is a multi-link operation (MLO). As most of the AP STAs and the non-AP STAs incorporate dual-band or tri-band capabilities, the newly developed MLO feature may enable packet-level link aggregation in the MAC layer across different PHY links. By performing load balancing according to traffic requirements, the MLO may achieve significantly higher throughput and lower latency for enhanced reliability in a heavily loaded network. With the MLO capability, a multi-link device (MLD) includes multiple affiliated devices to the upper logical link control (LLC) layer, allowing concurrent data transmission and reception in multiple channels across a single or multiple frequency bands in 2.4 GHz, 5 GHz and 6 GHz.

Today it is not uncommon to observe numerous devices operating on the same network. Many of such devices may be latency-tolerant but still contend with the devices with low-latency applications for the same time and frequency resources. In some cases, unregulated/unmanaged traffic may contend with the low-latency traffic within the infrastructure basic service set (BSS) of STAs served by the AP. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS). Each AP may form its own BSS and transmit and receive data with STAs associated with each AP.

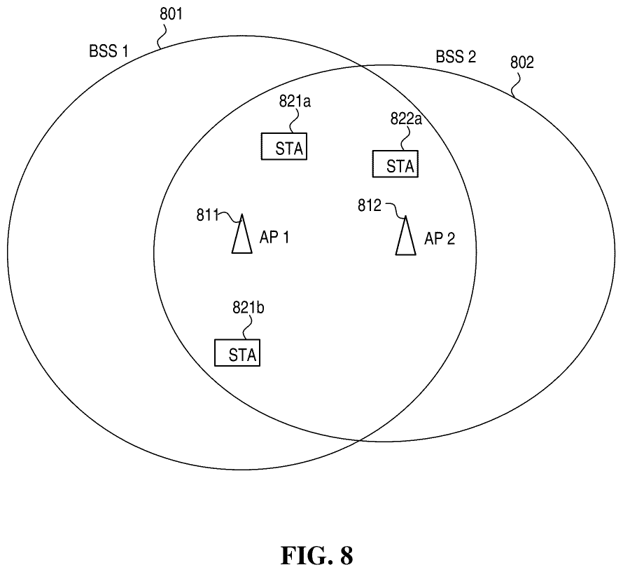

FIG. 8 shows an OBSS network topology in accordance with an embodiment.

As shown in FIG. 8, an AP1 station 811 forms a BSS1 801 and an AP2 station 812 forms a BSS 2 802. The AP 1 station 811 is associated with non-AP stations 821a and 821b and the AP2 station 812 is associated with a non-AP station 822a. Performance degradation of BSS 1 801 may occur due to interference caused by BSS 2 802 operating on the same channel and vice versa. To address this issue, Non-Primary Channel Access (NPCA) has been proposed, which allows STAs of BSS 1 801 to switch to an NPCA basic channel to transmit and receive data, avoiding interference. NPCA refers to a mechanism where, when interference occurs on the primary channel (BSS Primary Channel) due to external OBSS activity, the AP and STA (Station) switch to a pre-negotiated auxiliary channel (NPCA Primary Channel) to transmit data.

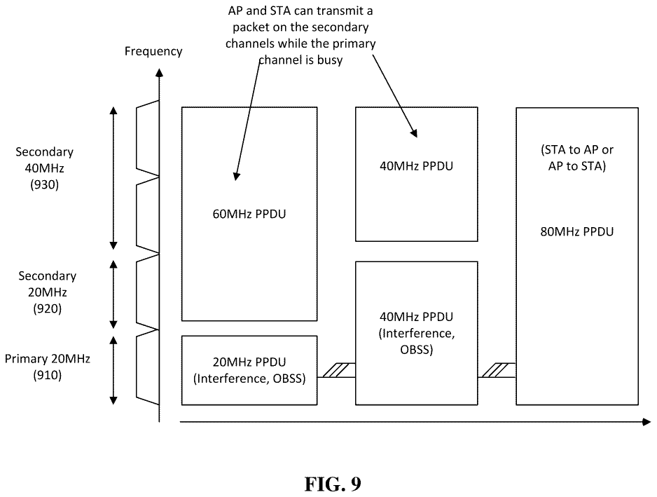

FIG. 9 shows scenarios for an NPCA when there is interference on the primary channel of a BSS from an OBSS in accordance with an embodiment.

The operating bandwidth of the BSS is 80 MHz and is divided into a 20 MHz primary channel 910 (BSS primary channel), a 20 MHz secondary channel 920, and a 40 MHz secondary channel 930. The 20 MHz secondary channel 920 and the 40 MHz secondary channel 930 may be considered as pre-negotiated auxiliary channels for use by the BSS when there is interference on the 20 MHz primary channel 910. For example, the 20 MHz secondary channel 920 may be the NPCA primary channel and the 40 MHz secondary channel 930 may be the NPCA secondary channel.

When a there is interference on the primary 20 MHz 910 from an OBSS, the AP and the STA of the BSS may switch to the 20 MHz secondary channel 920. When there is also interference on the 20 MHz secondary channel 920 from an OBSS, the AP and STA of the BSS may switch to the 40 MHz secondary channel 930. The AP and STA may thus transmit and receive packets on an NPCA basic channel when the BSS primary channel is busy.

However, there is a significant risk of communication disruption or reduced efficiency if the channel switching states of the AP and STAs do not align. For example, communication problems may arise in two scenarios. The first scenario is when the AP maintains the BSS primary channel while the STA switches to the NPCA basic channel. The second scenario is the converse of the first scenario, when the AP switches to the NPCA basic channel while the STA remains on the BSS primary channel.

Disclosed are techniques to maintain bidirectional communication and alleviate OBSS interference when a mismatch in channel switching states occurs between the AP and the STA.

In one embodiment of an NPCA operation, The AP and the STA announce their NPCA support capability through Beacon frames or Probe Request/Response frames. The AP may inform the STAs which channel is the NPCA primary channel. When the AP and STA receive HE/EHT/UHR PPDU (High-Efficiency/Extremely High Throughput/Ultra-High Reliability Physical Protocol Data Unit) signals from another BSS (OBSS) and determine them as interference, they may switch to the NPCA primary channel.

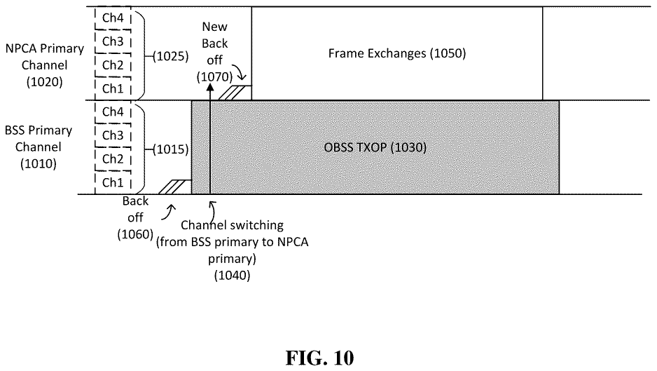

FIG. 10 shows channel switching by the AP and STA to the NPCA primary channel in accordance with an embodiment.

The operating bandwidth of the BSS is divided into the BSS primary channel 1010 and the NPCA primary channel 1020. The BSS primary channel 1010 is further divided into four sub-channel Ch1-Ch4 (1015). The NPCA primary channel 1020 is also divided into four sub-channels Ch1-Ch4 (1025).

The AP and STA of the BSS initially operate on the BSS primary channel 1010. The BSS may use a back counter 1960 for contention-based access. When the AP and STA detect interference on the BSS primary channel 1010, such as when the AP and STA detect traffic signals from an OBSS, represented as transmit opportunity (TXOP) 1030 from the OBSS, the AP and STA switch from the BSS primary channel 1010 to the NPCA primary channel 1020 at time 1040.

After the channel switch, the BSS may set a new backoff counter 1070, and reinitialize and apply EDCA (Enhanced Distributed Channel Access) rules to the NPCA primary channel 1020 to provide a QoS mechanism for different access categories. The AP and STA may then conduct frame exchanges 1050 under the updated rules on the NPCA primary channel 1020.

FIG. 10 shows a symmetrical switching scenario when both the AP and STA of the BSS detect traffic signals from the OBSS. However, in the conventional NPCA operation, due to different physical distances and positionings, situations may arise where either the AP or STA, but not both, detects traffic signals from the OBSS.

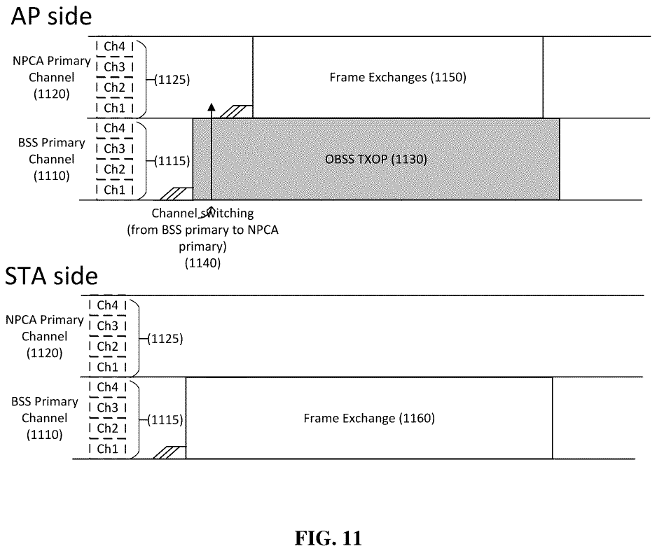

FIG. 11 shows an asymmetrical switching scenario when channel switching to the NPCA primary channel occurs for the AP but not for the STA.

The operating bandwidth of the BSS is divided into the BSS primary channel 1110 and the NPCA primary channel 1120. As in FIG. 10, the BSS primary channel 1110 is further divided into four sub-channel Ch1-Ch4 (1115). The NPCA primary channel 1120 is also divided into four sub-channels Ch1-Ch4 (1125).

The AP and STA initially operate on the BSS primary channel 1110. When the AP detects traffic signals from an OBSS, represented as TXOP 1130 from the OBSS, the AP switches from the BSS primary channel 1110 to the NPCA primary channel 1120 at time 1140. On the other hand, the STA does not detect traffic signals from the OBSS due its physical distance and positioning from the OBSS. Because the STA does not detect interference from the OBSS, the STA conducts frame exchanges 1160 using the BSS primary channel 1110.

In such an asymmetric NPCA environment, the AP and STA might end up communicating on different channels. To ensure stable and efficient data transmission under such circumstances, it is desirable to define the channel switching procedures and data transmission protocols so that communication may be maintained smoothly when NPCA switching occurs asymmetrically, i.e., when only one of the AP or STA switches to the NPCA primary channel. The following discussions pertain to the two asymmetrical NPCA switching scenarios.

The first scenario is when only the STA switches to the NPCA primary channel. In this scenario, the AP does not detect traffic signals from the OBSS and remains on the BSS primary channel, whereas the STA detects OBSS traffic signals and switches to the NPCA primary channel.

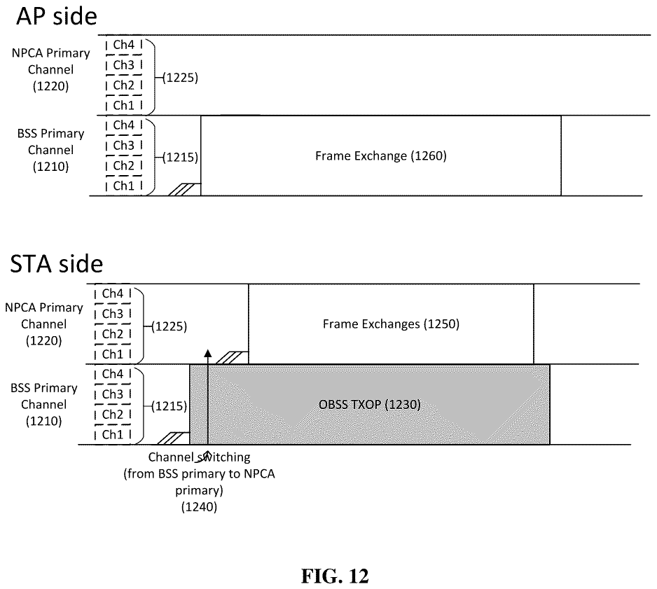

FIG. 12 shows an asymmetrical NPCA switching scenario when channel switching to the NPCA primary channel occurs for the STA but not for the AP under this first scenario.

The operating bandwidth of the BSS is divided into the BSS primary channel 1210 and the NPCA primary channel 1220. As in FIG. 10 and FIG. 11, the BSS primary channel 1210 is further divided into four sub-channel Ch1-Ch4 (1215). The NPCA primary channel 1220 is also divided into four sub-channels Ch1-Ch4 (1225).

The AP and STA initially operate on the BSS primary channel 1210. When the STA detects traffic signals from an OBSS, represented as TXOP 1230 from the OBSS, the STA switches from the BSS primary channel 1210 to the NPCA primary channel 1220 at time 1240. On the other hand, the AP does not detect traffic signals from the OBSS due its physical distance and positioning from the OBSS. If the AP does not implement a data transmission protocol to determine whether the STA has switched to the NPCA primary channel, the AP and the STA may not be able communicate when the AP assumes frame exchanges 1260 are still taking place using the BSS primary channel 1210.

Under the first asymmetrical NPCA switching scenario when the STA, but not the AP, switches to the NPCA primary channel, the AP or the STA may have data to transmit after acquiring a TXOP. The data transmission protocols when either the AP or the STA has data to transmit after acquiring a TXOP will be discussed separately.

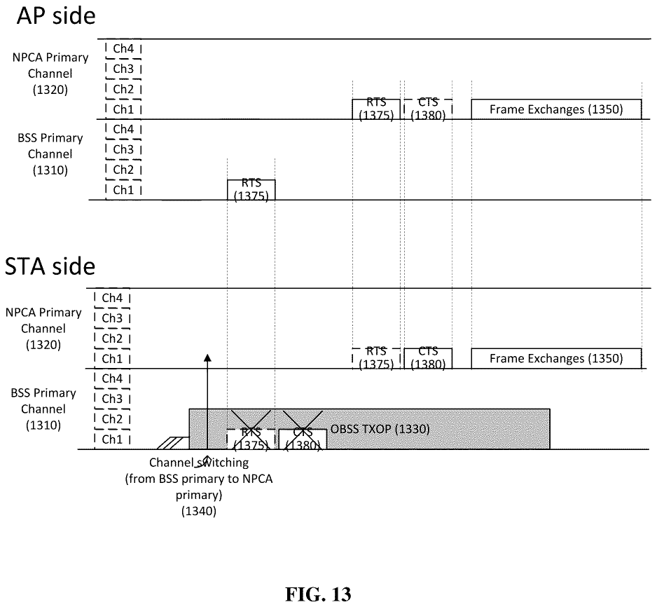

FIG. 13 shows a data transmission protocol for the AP to determine if an NPCA-supported STA (NPCA STA) has switched to the NPCA primary channel when the AP acquires a TXOP in accordance with one embodiment.

The AP and NPCA STA initially operate on the BSS primary channel 1310. When the NPCA STA detects traffic signals from an OBSS, represented as TXOP 1330 from the OBSS, the NPCA STA switches from the BSS primary channel 1310 to the NPCA primary channel 1320 at time 1340. On the other hand, the AP does not detect traffic signals from the OBSS and remains on the BSS primary channel 1310.

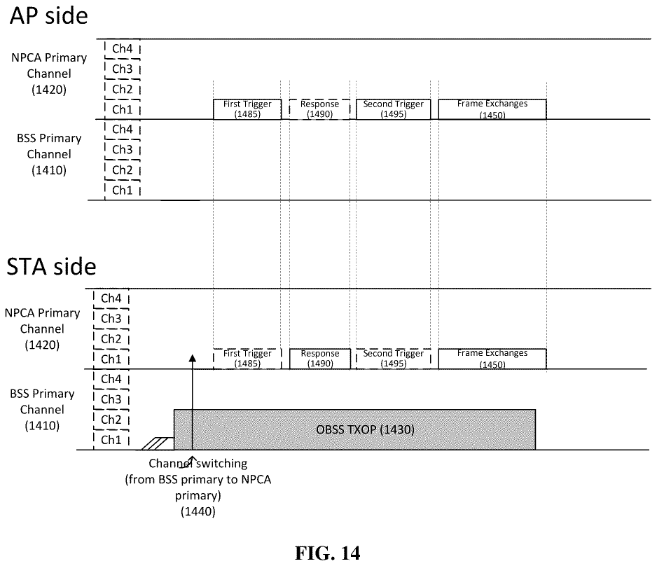

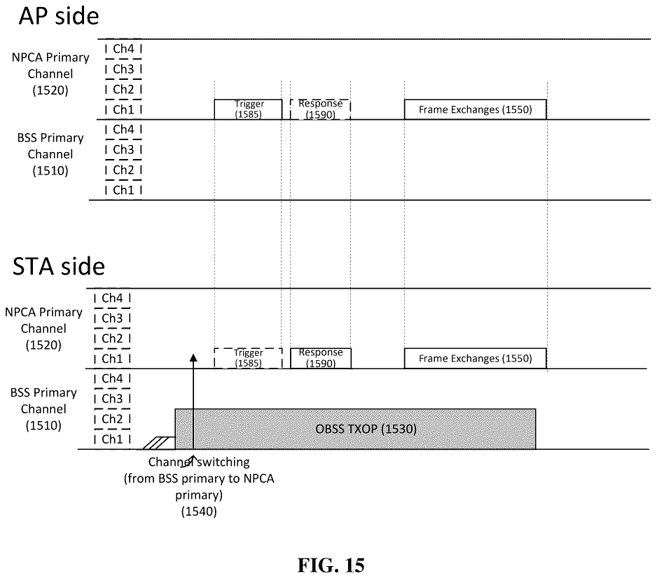

The AP may acquire a TXOP. If the AP wants to transmit data traffic to the NPCA STA, it cannot be certain whether the NPCA STA has switched to the NPCA primary channel 1320. Therefore, the AP may first transmit an RTS (Request to Send) frame 1375 through the BSS primary channel 1310. Because the NPCA STA has switched to the NPCA primary channel 1320, the NPCA STA does not receive the RTS frame 1375 on the BSS primary channel 1310. As such, the NPCA STA does not generate a CTS response 1380. (In FIG. 13 and the following FIG. 14 and FIG. 15, on the AP side, solid boxes represent signals that the AP transmits to the STA, and dotted boxes represent signals that the AP receives from the STA. On the STA side, solid boxes represent signals that the STA transmits to the AP, and dotted boxes represent signals that the STA receives from the AP.)

The AP may check for a CTS response 1380 from the NPCA STA on the BSS primary channel 1310. Because the NPCA STA did not receive the RTS frame 1375 to trigger a CTS response 1380, the AP does not receive a CTS response 1380 on the BSS primary channel 1310. The AP assumes that the NPCA STA has switched to the NPCA primary channel 1320.

The AP, which did not receive a CTS response 1380 on the BSS primary channel 1310, retransmits the RTS frame 1375 on the NPCA primary channel 1320 and waits for the NPCA STA to send a CTS response frame 1380 back through the NPCA primary channel 1320.

The NPCA STA, which has switched to the NPCA primary channel 1320, receives the RTS frame 1375 sent by the AP and replies with a CTS frame 1380 through the NPCA primary channel 1320.

Upon receiving the CTS frame 1380, the AP transmits data traffic to the NPCA STA through the NPCA primary channel 1320. The AP and the NPCA STA may conduct frame exchanges 1350 through the NPCA primary channel 1320. In one embodiment, if the AP is aware that the NPCA STA has switched to the NPCA primary channel, the AP skips sending the RTS frame 1375 via the BSS primary channel 1310 and directly transmits the RTS frame 1375 or data traffic through the NPCA primary channel 1320.

In one embodiment of the first asymmetrical NPCA switching scenario when the STA, but not the AP, switches to the NPCA primary channel, the STA may have data to transmit after acquiring a TXOP. However, the STA cannot directly transmit data traffic to the AP through the NPCA primary channel. This is because the AP may not have switched to the NPCA primary channel, which may cause communication issues. To resolve this asymmetric issue, the STA that has switched to the NPCA primary channel waits for the AP to transmit a trigger frame.

The AP may periodically transmit trigger frames through the NPCA primary channel to verify whether one or more NPCA STAs associated with the AP have switched to the NPCA primary channel. In one embodiment, when the AP transmits a trigger frame, it periodically includes information to check whether the NPCA STAs have switched to the NPCA primary channel. For example, when performing RU (Resource Unit) allocation through a trigger frame, the AP assigns RUs corresponding to the NPCA primary channel to the NPCA STAs. This ensures that the STAs that have switched to the NPCA primary channel can transmit data traffic to the AP.

FIG. 14 shows a data transmission protocol for the AP to determine if an NPCA STA has switched to the NPCA primary channel when the NPCA STA acquires a TXOP in accordance with one embodiment.

The AP and NPCA STA initially operate on the BSS primary channel 1410. When the NPCA STA detects traffic signals from an OBSS, represented as TXOP 1430 from the OBSS, the NPCA STA switches from the BSS primary channel 1410 to the NPCA primary channel 1420 at time 1440.

The NPCA STA may acquire a TXOP after switching to the NPCA primary channel 1420. However, The NPCA STA does not directly transmit data traffic to the AP through the NPCA primary channel 1420. Instead, the NPCA STA waits for a trigger frame from the AP.

The AP transmits a first trigger frame 1485 to a plurality of STAs associated with the AP through the NPCA primary channel 1420 to verify whether the plurality of STAs associated with the AP have switched to the NPCA primary channel 1420. The first trigger frame 1485 includes RU allocation information indicating RUs allocated to the plurality of STAs associated with the AP.

The NPCA STA receives the first trigger frame 1485. In response to the first trigger frame 1485, the NPCA STA transmits a response frame 1490 including information indicating that the NPCA STA has switched to the NPCA primary channel 1420. The NPCA STA transmits the response frame 1490 through an RU which is allocated to the NPCA STA by the first trigger frame 1485.

In response to the response frames 1490 from the NPCA STA or any of the other STAs, the AP transmits a second trigger frame 1495 through the NPCA primary channel 1420 to a plurality of STAs including one or more NPCA STAs which switched to the NPCA primary channel 1420. The second trigger frame 1495 may trigger the one or more NPCA STAs to transmit traffic data to the AP. The second trigger frame 1495 includes RU allocation information indicating RUs allocated to the one or more NPCA STAs associated with the AP.

The NPCA STA receives the second trigger frame 1495. In response to the second trigger frame 1495, the NPCA STA transmits traffic data to the AP through an RU which is allocated to the NPCA STA by the second trigger frame 1495. The AP and the NPCA STA may conduct frame exchanges 1450 through the NPCA primary channel 1420.

In one embodiment, after transmitting a response frame to notify the AP that the NPCA STA has switched to the NPCA primary channel, the NPCA STA may initiate a random access procedure to gain access to the NPCA primary channel to transmit data without waiting for the second trigger frame.

FIG. 15 shows a data transmission protocol for the AP to determine if an NPCA STA has switched to the NPCA primary channel when the NPCA STA acquires a TXOP in accordance with another embodiment.

The AP and NPCA STA initially operate on the BSS primary channel 1510. When the NPCA STA detects traffic signals from an OBSS, represented as TXOP 1530 from the OBSS, the NPCA STA switches from the BSS primary channel 1510 to the NPCA primary channel 1520 at time 1540.

The NPCA STA acquires a TXOP after switching to the NPCA primary channel 1420. As in FIG. 14, the NPCA STA cannot directly transmit data traffic to the AP through the NPCA primary channel 1420. The NPCA STA waits for a trigger frame.

The AP transmits a trigger frame 1585 to a plurality of STAs associated with the AP through the NPCA primary channel 1520 to verify whether the plurality of STAs associated with the AP have switched to the NPCA primary channel 1520. The trigger frame 1585 includes RU allocation information indicating RUs allocated to the plurality of STAs associated with the AP.

The NPCA receives the trigger frame 1585. In response to the trigger frame 1585, the NPCA STA transmits a response frame 1590 including information indicating that the NPCA STA has switched to the NPCA primary channel 1520. The NPCA STA transmits the response frame 1590 through an RU which is allocated to the NPCA STA by the trigger frame 1585.

The NPCA STA may transmit traffic data to the AP through the NPCA primary channel 1520 because the NPCA STA has notified the AP that the NPCA STA has switched to the NPCA primary channel 1520. When the NPCA STA has traffic data to send, the NPCA STA randomly accesses the NPCA primary channel 1520. If the NPCA STA wins the random access, the NPCA STA transmits traffic data to the AP through the NPCA primary channel 1520. The AP and the NPCA STA may then conduct frame exchanges 1550 through the NPCA primary channel 1520.

In a second scenario of an asymmetrical NPCA switching scenario, the AP but not the STA may detect interference on the BSS primary channel as depicted in FIG. 11. In one embodiment, the AP may instruct the STAs in the BSS to switch to the NPCA primary channel.

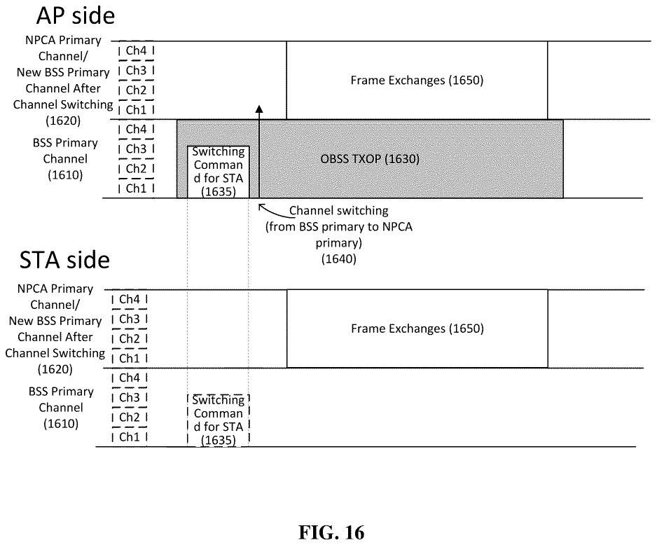

FIG. 16 shows a channel switching procedure for the AP to command STAs associated with the AP to switch to the NPCA primary channel in accordance with one embodiment.

The AP and STA initially operate on the BSS primary channel 1610. The AP detects traffic signals from an OBSS, represented as TXOP 1630 from the OBSS. On the other hand, the STA does not detect traffic signals from the OBSS due its physical distance and positioning from the OBSS. To resolve the asymmetric issue arising in this scenario, the AP issues a switching command 1635 on the BSS primary channel 1610 to instruct the NPCA STAs associated with the BSS to switch from the BSS primary channel 1610 to the NPCA primary channel 1620 before AP switches itself. The AP then switches from the BSS primary channel 1610 to the NPCA primary channel 1620 at time 1640.

Once the AP and all NPCA STAs within the BSS have switched to the NPCA primary channel 1620, the NPCA primary channel 1620 is regarded as the new BSS primary channel. The AP and NPCA STAs then communicate through the NPCA primary channel 1620 using the same communication method previously used on the BSS primary channel 1610 before the channel switching occurred. For example, the AP and the NPCA STAs may conduct frame exchanges 1650 through the NPCA primary channel 1620.

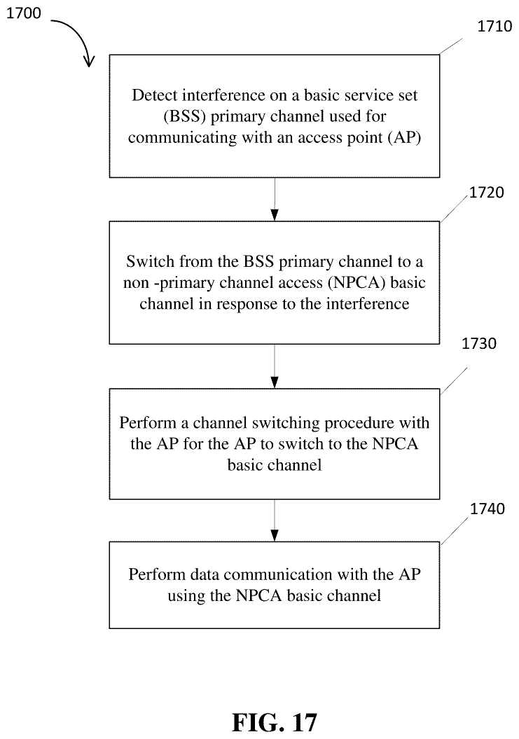

FIG. 17 shows an example process 1700 for a STA to switch from a BSS primary channel to a NPCA primary channel in accordance with one embodiment. For explanatory and illustration purposes, the example processes 1700 may be performed by a non-AP STA (e.g., Non-AP STA 12 as described with reference to FIG. 1 or the STA 821a, 821b, or 822a with reference to FIG. 8). Although one or more operations are described or shown in particular sequential order, in other embodiments the operations may be rearranged in a different order, which may include performance of multiple operations in at least partially overlapping time periods.

Referring to FIG. 17, the process 1700 may begin in operation 1710. In operation 1710, a STA (e.g., a processor of the STA) detects interference on a BSS primary channel used for communicating with an AP.

In operation 1720, the STA switches from the BSS primary channel to a non-primary channel access (NPCA) basic channel in response to the interference.

In operation 1730, the STA performs a channel switching procedure with the AP for the AP to switch to the NPCA basic channel.

In operation 1740, the STA performs data communication with the AP using the NPCA basic channel.

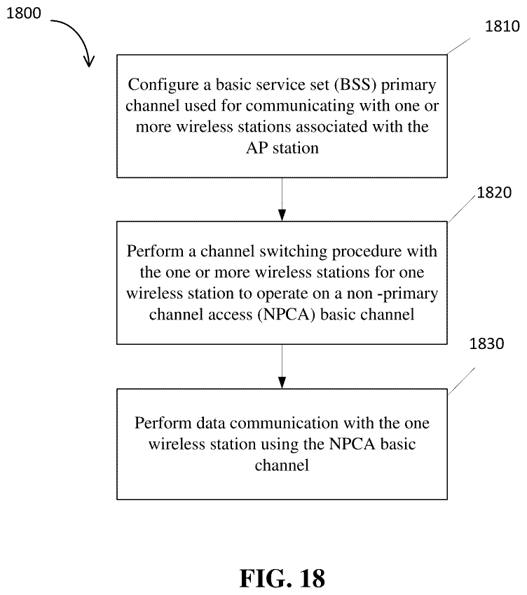

FIG. 18 shows an example process 1800 for an AP to switch from a BSS primary channel to a NPCA primary channel in accordance with one embodiment. For explanatory and illustration purposes, the example processes 1800 may be performed by an AP STA (e.g., AP STA 11 as described with reference to FIG. 1 or the AP1 811 or AP2 812 with reference to FIG. 8). Although one or more operations are described or shown in particular sequential order, in other embodiments the operations may be rearranged in a different order, which may include performance of multiple operations in at least partially overlapping time periods.

Referring to FIG. 18, the process 1800 may begin in operation 1810. In operation 1810, an AP (e.g., a processor of the AP) configures a BSS primary channel used for communicating with one or more wireless stations associated with the AP.

In operation 1820, the AP performs a channel switching procedure with the one or more wireless stations for one wireless station to operate on a non-primary channel access (NPCA) basic channel.

In operation 1830, the AP performs data communication with the one wireless station using the NPCA basic channel.

The various illustrative blocks, units, modules, components, methods, operations, instructions, items, and algorithms may be implemented or performed with a processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A wireless communication device for facilitating wireless communication, comprising processing circuitry configured to cause:
detecting interference on a basic service set (BSS) primary channel used for communicating with an access point (AP);
switching from the BSS primary channel to a non-primary channel access (NPCA) basic channel in response to the interference;
performing a channel switching procedure with the AP for the AP to switch to the NPCA basic channel; and
performing data communication with the AP using the NPCA basic channel.

2. The wireless communication device of claim 1, wherein said performing a channel switching procedure with the AP for the AP to switch to the NPCA basic channel comprises:
receiving a trigger frame from the AP on the NPCA basic channel; and
transmitting a response frame to the AP on the NPCA basic channel to indicate the switching from the BSS primary channel to the NPCA basic channel in response to the trigger frame.

3. The wireless communication device of claim 2, wherein the trigger frame comprises resource allocation information corresponding to the NPCA basic channel.

4. The wireless communication device of claim 3, wherein said transmitting a response frame to the AP comprises:
transmitting the response frame to the AP on the NPCA basic channel to indicate the switching to the NPCA basic channel using a resource unit allocated based on the resource allocation information.

5. The wireless communication device of claim 2, wherein said performing a channel switching procedure with the AP for the AP to switch to the NPCA basic channel further comprises:
receiving a second trigger frame from the AP on the NPCA basic channel, wherein the second trigger frame includes resource allocation information corresponding to the NPCA basic channel, and
wherein said performing data communication with the AP comprises:
transmitting data to the AP using a resource unit allocated based on the resource allocation information.

6. The wireless communication device of claim 2, wherein said performing a channel switching procedure with the AP for the AP to switch to the NPCA basic channel further comprises:
transmitting a random access request to the AP on the NPCA basic channel as part of a random access procedure; and
receiving access to the NPCA basic channel, and
wherein said performing data communication with the AP comprises:
transmitting data to the AP on the NPCA basic channel.

7. The wireless communication device of claim 1, wherein said performing a channel switching procedure with the AP for the AP to switch to the NPCA basic channel comprises:
receiving a request to send (RTS) frame on the NPCA basic channel; and
transmitting a clear to send (CTS) frame on the NPCA basic channel.

8. The wireless communication device of claim 1, wherein said detecting interference on a BSS primary channel comprises:
detecting a transmit opportunity from an overlapping basic service set (OBSS).

9. A wireless communication device for facilitating wireless communication, comprising processing circuitry configured to cause:
receiving a switching command from an access point (AP) on a basic service set (BSS) primary channel used for communicating with the AP;
switching from the BSS primary channel to a non-primary channel access (NPCA) basic channel in response to the switching command; and
performing data communication with the AP using the NPCA basic channel.

10. An access point (AP) station for facilitating wireless communication, comprising processing circuitry configured to cause:
configuring a basic service set (BSS) primary channel used for communicating with one or more wireless stations associated with the AP station;
performing a channel switching procedure with the one or more wireless stations for one wireless station to operate on a non-primary channel access (NPCA) basic channel; and
performing data communication with the one wireless station using the NPCA basic channel.

11. The AP station of claim 10, wherein said performing a channel switching procedure with the one or more wireless stations for the one wireless station to operate on the NPCA basic channel comprises:
transmitting a trigger frame to the one or more wireless stations on the NPCA basic channel; and
receiving a response frame from the one wireless station on the NPCA basic channel to indicate the one wireless station switched from the BSS primary channel to the NPCA basic channel.

12. The AP station of claim 11, wherein the trigger frame comprises resource allocation information to allocate a resource unit corresponding to the NPCA basic channel.

13. The AP station of claim 12, wherein said receiving a response frame from the one wireless station comprises:
receiving the response frame from the one wireless station on the NPCA basic channel on the resource unit allocated by the resource allocation information.

14. The AP station of claim 11, wherein said performing a channel switching procedure with the one or more wireless stations for the one wireless station to operate on the NPCA basic channel further comprises:
transmitting a second trigger frame to the one wireless station on the NPCA basic channel in response to the response frame, wherein the second trigger frame includes resource allocation information to allocate a resource unit corresponding to the NPCA basic channel, and
wherein said performing data communication with the one wireless station comprises:
receiving data from the one wireless station on a resource unit allocated by the resource allocation information.

15. The AP station of claim 11, wherein said performing a channel switching procedure with the one or more wireless stations for the one wireless station to operate on the NPCA basic channel further comprises:
receiving a random access request from the one wireless station on the NPCA basic channel as part of a random access procedure; and
granting, to the one wireless station, access to the NPCA basic channel; and
wherein said performing data communication with the one wireless station comprises:
receiving data from one wireless station on the NPCA basic channel.

16. The AP station of claim 10, wherein said performing a channel switching procedure with the one or more wireless stations for the one wireless station to operate on the NPCA basic channel comprises:
transmitting a request to send (RTS) frame on the BSS primary channel to the one or more wireless stations;
determining a failure to receive a clear to send (CTS) frame on the BSS primary channel from the one or more wireless stations;
retransmitting the RTS frame on the NPCA basic channel to the one or more wireless stations; and
receiving a CTS frame from the one wireless station on the NPCA basic channel.

17. The AP station of claim 10, wherein said performing a channel switching procedure with the one or more wireless stations for the one wireless station to operate on the NPCA basic channel comprises:
determining that the one wireless station is operating on the NPCA basic channel;
transmitting a request to send (RTS) frame on the NPCA basic channel to the one wireless station; and
receiving a clear to send (CTS) frame from the one wireless station on the NPCA basic channel.

18. The AP station of claim 17, wherein said determining that the one wireless station is operating on the NPCA basic channel comprises:
transmitting a trigger frame to the one or more wireless stations on the NPCA basic channel; and
receiving a response frame from the one wireless station on the NPCA basic channel to indicate the one wireless station switched from the BSS primary channel to the NPCA basic channel.

19. The AP station of claim 10, wherein said performing a channel switching procedure with the one or more wireless stations for the one wireless station to operate on the NPCA basic channel comprises:
detecting interference on the BSS primary channel;
transmitting a command on the BSS primary channel to instruct the one or more wireless stations to switch from the BSS primary channel to the NPCA basic channel; and
switching the AP station from the BSS primary channel to the NPCA basic channel for communicating with the one or more wireless stations.

20. The AP station of claim 19, wherein said detecting interference on the BSS primary channel comprises:
detecting a transmit opportunity from an overlapping basic service set (OBSS).
